(19) United States
(12) Patent Application Publication
(10) Pub. No.: US 2025/0005730 A1
(43) Pub. Date: Jan. 2, 2025

(54) Measuring Perceptibility Of Content In A Virtual Universe

(71) Applicant: Oracle International Corporation, Redwood Shores, CA (US)

(72) Inventors: Christopher Henric Troein, New York, NY (US); Gillian McGovern, New York, NY (US); David Perrotti, Oakland, CA (US); Eric L. Sutton, Naperville, IL (US)

(73) Assignee: Oracle International Corporation, Redwood Shores, CA (US)

(21) Appl. No.: 18/636,871

(22) Filed: Apr. 16, 2024

Related U.S. Application Data
(60) Provisional application No. 63/510,586, filed on Jun. 27, 2023.

(51) Int. Cl. G06T 7/00; G06T 7/70; G06T 15/10

(52) U.S. Cl. CPC G06T 7/0002; G06T 7/70; G06T 15/10; G06T 2200/04

(57) ABSTRACT

Techniques for determining perceptibility of content displayed within virtual universes are disclosed. Operations include calculating a cube map of a scene in the virtual universe at a location with a view of a target object. Using the cube map, first and second visibility scores are computed for the target object. A perceptibility score for the target object is determined by combining the first and second visibility scores. Computing the visibility scores includes generating an image representing the scene in a face of the cube map including obstructions and visual effects. The operations further include generating another image representing the scene in the face of the cube map without including the obstructions and visual effects. Additionally, the operations include determining the visibility score by comparing the two images.

### BENEFIT CLAIMS; RELATED APPLICATIONS; INCORPORATION BY REFERENCE

This application claims the benefit of U.S. Provisional Patent Application No. 63/510,586, filed Jun. 27, 2023, that is hereby incorporated by reference.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure generally relates to virtual universes, and more specifically, to analyzing the perceptibility of content displayed within virtual universes.

### BACKGROUND

Virtual universes allow people to socialize and interact in computer-generated environments. A virtual universe may, for example, represent a city using three-dimensional (3D) graphics simulating interactive landscapes, flora, fauna, characters, buildings, vehicles, and other objects. Using a computer interface, a user may control an avatar within a virtual universe to explore environments, manipulate objects, communicate with other users, perform activities, interact with information content, and participate in commerce. Examples of virtual universes include virtual reality games, immersive social platforms, training simulations, and virtual worlds for research and experimentation.

The approaches described in this section are approaches that could be pursued, but not necessarily approaches that have been previously conceived or pursued. Therefore, unless otherwise indicated, one should not assume that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. References to “an” or “one” embodiment in this disclosure are not necessarily to the same embodiment, and they mean at least one. In the drawings:

FIG. 1 illustrates an example system environment for measuring effectiveness of advertisements in a virtual universe in accordance with one or more embodiments;

FIG. 2 illustrates an example virtual universe system in accordance with one or more embodiments;

FIGS. 3A, 3B, and 3C illustrate an example process for measuring effectiveness of content in a virtual universe in accordance with one or more embodiments;

FIGS. 4A, 4B, and 4C illustrate an example embodiment of determining visual perceptibility in accordance with one or more embodiments; and

FIG. 5 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram to avoid unnecessarily obscuring the present disclosure.
1. GENERAL OVERVIEW
2. SYSTEM ENVIRONMENT FOR MEASURING PERCEPTIBILITY OF CONTENT
3. VIRTUAL UNIVERSE SYSTEM ARCHITECTURE
4. MEASURING PERCEPTIBILITY OF CONTENT
5. EXAMPLE OF DETERMINING IMAGES FOR COMPUTING VISUAL PERCEPTIBILITY
6. HARDWARE OVERVIEW
7. MISCELLANEOUS; EXTENSIONS

### 1. General Overview

The present disclosure relates to analyzing the perceptibility of content displayed within virtual universes. Perception of content is affected by obstructions and audiovisual effects occurring in the virtual universe. For example, virtual objects may obscure the perception of content by blocking a user's viewpoint. Additionally, virtual lighting may obscure the perception of the content by shifting the content's color to simulate glare, shadows, reflections, smoke, etc. Further, audio effects, such as music and sound effects, may obscure the perception of content by interfering with and attenuating audio emitted from the object. Consequently, obstructions and audiovisual effects may decrease the effectiveness of content presented to users.

Content may be media, such as images, animations, audio, video, and combinations thereof. Content may include informational, entertainment, educational, social, and promotional material. One or more embodiments overlay content on displayed virtual objects, determine perceptibility of the objects, and evaluate the effectiveness of the content based on the perceptibility.

An example system determines a perceptibility score by calculating a visibility score and an audibility score of the target object from a location. Target objects are virtual objects configured to display different content of one or more content providers. For example, a target object may be a virtual billboard or a virtual television that selectively displays promotional content from various advertisers. The location may be a viewpoint of a user within the visual rendering distance of the target object. The visibility score quantifies the visual perceptibility of the target object from the location. One or more embodiments calculate the visibility score by determining the difference between (a) an image of the content rendered with visibility factors and (b) an image of content rendered without the visibility factors. Visibility factors include obstructions and visual effects. Obstructions may be any object in the virtual universe that obscures viewing of content from the location. For example, an obstruction may be a vehicle parked between the location and the target object. Visual effects include shading, particle effects, and texture effects. Shading includes color-shifting of objects due to lighting and viewing angle. Particle effects include color shifting of objects due to smoke, dust, lens flare, etc. Texture effects include color shifting of objects due to luminance, translucence, and reflectivity of textures.

One or more embodiments determine the visibility score for a target object from a particular location based on the representation of the target object within a cube map corresponding to the location. A cube map is a texture map that simulates visual effects in a virtual universe. The system determines a cube map by rendering six two-dimensional (2D) images of a scene from multiple perspectives at the particular location. Based at least in part on a representation of the target object within the surfaces of the cube map, the system computes a perceptibility score for the target object, within the virtual reality environment, from the perspectives of the particular location. The system may compute the perceptibility score based on a combination of visibility scores for the target object that are respectively associated with each surface of the cube map.

The visibility score, for the target object, associated with a surface of the cube map is based at least in part on a representation of the target object within the surface. The visibility score, for the target object, associated with the surface may be based on (a) a first image that represents the objects within the surface including the target object and (b) a second image that represents the target object within the surface without representing the other objects within the surface.

In an example, using the cube map, the system renders an initial image that represents a surface of the cube map including the target object as well as any other objects, obstructions, and visual effects in the scene from the perspective of the location. From the initial image, the system generates an updated image that represents the target object in the surface of the cube map without representing the other objects, obstructions, and visual effects. The system calculates a visibility score for the content by comparing the first image to the second image. One or more embodiments perform a pixel-by-pixel comparison of the first image and the second image and then determine if corresponding pixels match. Some embodiments determine whether or not pixels match based on metadata embedded in an object model or textures of the target object. For example, the textures of the target object may incorporate identification information in red-green-blue-alpha (RGBA) data. Some embodiments determine if pixels match based on calculating a perceptual color difference between corresponding pixels. For example, the system may determine that pixels match if the pixels have a perceptual color difference value greater than a predetermined threshold.

One or more embodiments determine the audibility score of the content at the location. The system may simulate audio effects generated from sources in the virtual universe and audible at the location. The system may simulate the audio effects rendered for (a) the content and ambient sounds of the virtual universe and (b) the content alone. Then the system calculates the audibility score quantifying the difference between the first simulation and the second simulation.

One or more embodiments select a target object for presenting content based on the perceptibility score of the target object. The system may select the target object by comparing the perceptibility score of the target object to perceptibility scores of other target objects. Additionally, using the respective perceptibility scores of the target objects, the system may assign the target objects relative compensation values for placing content on the target objects by content providers.

One or more embodiments generate performance reports for content displayed in the virtual universe. The reports may analyze performance of content based on the quantity, quality, and effectiveness of impressions that occurred in the virtual universe. Performance information may describe the perceptibility of the content, user interactions with the content, and conversion of the impressions into commercial activity. Additionally, the reports may indicate an approximate number of impressions associated with different locations. For example, the report may indicate content views from different locations around a target object. Further, the reports may indicate differential details of content in different contexts at the same or substantially same location of a virtual environment. The contexts include, for example, time of day, type of location, weather, or other events. The report may also include comparisons of metrics (e.g., time, user traffic, and population) at two different time periods, such as a time that content was placed versus a current time.

Additionally, one or more embodiments capture recordings that represent how users perceive content in the virtual universe. The system may record videos, images, and/or sounds of content presented on a target object from the location. For example, the systems may record video clips at particular times and/or periodic times (e.g., every second, minute, hour, etc.). One or more embodiments use the recorded information in the reports as examples of content impressions. The reports may also include information projecting impressions and purchases resulting from the impressions.

One or more embodiments track users to determine subsequent purchase activity (e.g., conversions) related to content impressions. The system may track purchases inside and outside the virtual universe associated with content displayed in the virtual universe. In-virtual universe purchase activity may be inferred from an inventory of a user's avatar. Purchases external to the virtual universe may be inferred by linking user in-virtual universe user profiles with real-world user profiles.

One or more embodiments described in this Specification and/or recited in the claims may not be included in this General Overview section.

### 2. System Environment for Measuring Perceptibility of Content

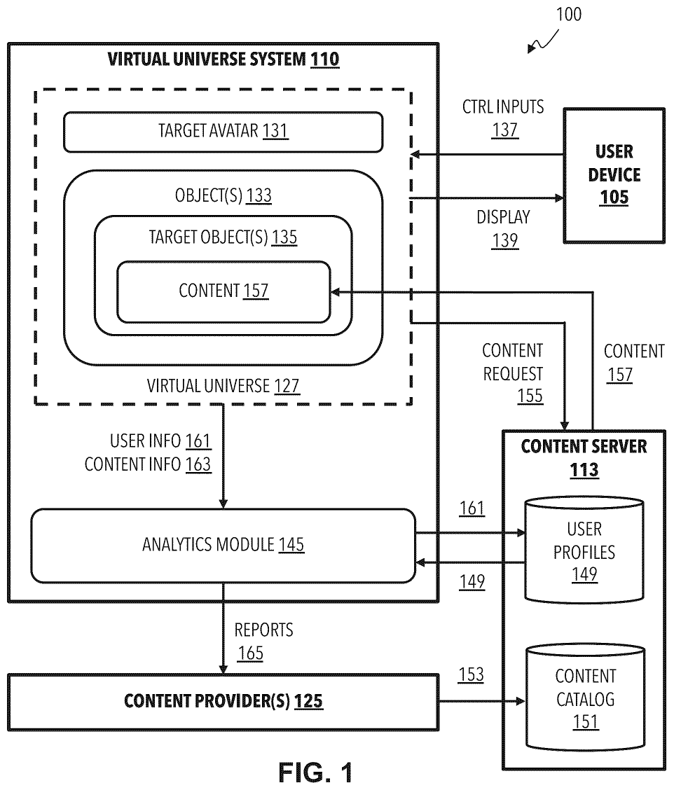

FIG. 1 is an block diagram of an example system environment 100 in accordance with aspects of the present disclosure. The system environment 100 is an example embodiment. Other embodiments in accordance with the present disclosure may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications, modules, and/or machines. Multiple components may be combined into one application, module, and/or machine. Operations described with respect to one component may instead be performed by another component.

The system environment 100 includes a user device 105, a virtual universe (“VU”) system 110, a content server 113, and content providers 125 communicatively linked by one or more communication links. The communication links may be wired and/or wireless information communication channels, such as the Internet, an intranet, an Ethernet network, a wireline network, a wireless network, a mobile communications network, and/or another communication network.

The user device 105 is one or more computing devices communicatively linked with the system 110 that interacts with the virtual universe 127 and content presented in the virtual universe. For example, the user device 105 may be a personal computer, workstation, server, mobile device, mobile phone, tablet device, and/or other processing device capable of implementing and/or executing software, applications, etc. The user device 105 generates a computer-user interface enabling a user to access, perceive, and interact with the virtual universe 127 via a user avatar 131 using input/output devices, such as be a video display, an audio apparatus, a pointer device, a keyboard device, and/or a tactile feedback device.

The virtual universe system 110 is one or more computing devices that generate, update, manage, and control the virtual universe 127. The virtual universe 127 is a computer-generated environment that simulates aspects of real-world or fictional environments. The virtual universe 127 incorporates elements of physics that allow for realistic interactions and simulations of natural phenomena, physical interactions, and social behaviors. The virtual universe 127 may vary in scale and complexity. For example, the virtual universe 127 may simulate a specific region or scenario or replicate one or more interconnected worlds.

The virtual universe 127 includes a target avatar 131 and objects 133, including a target object 135. The target avatar 131 is a digital representation of a user within the virtual universe 127. The user device 105 controls and interacts with the virtual universe 127 through the target avatar 131. The target avatar 131 may be, for example, a humanoid, an animal, a vehicle, a pointer, or even an abstract, depending on the design of the virtual universe. The system 110 receives and processes control inputs 137 from the user device 105 for controlling a user avatar 131 in the virtual universe 127. Also, the system 110 generates a virtual universe display 139 for presentation by the user device 105 that graphically represents the virtual universe 127 in two-dimensions (2D) from a viewpoint of the user avatar 131. The system 110 may update the virtual universe display 139 in real time or near real time based on the control inputs 137 that change the target avatar's 131 location or viewpoint.

The objects 133 are three-dimensional (3D) models representing items, characters, structures, terrain, landscapes, flora, fauna, vehicles, and other simulated elements in the virtual universe. The 3D models define the visual appearance and geometry of the objects. Items include, for example, furniture, tools, weapons, and the like. Characters may be non-player characters (NPCs) controlled by the system. The models may be programmed or scripted to respond to user actions or environmental conditions. For example, a switch may trigger a door object to open, or a button object may activate an NPC script.

A target object 135 is any type of object 133 that displays the content 157 in the virtual universe 127. For instance, the target object 135 may be a virtual billboard, and the content 157 may be an advertisement displayed by the billboard. The target object 135 may be programmed to perform interactive or scripted behaviors using the content 157. The user may, for example, interact with the target object 135 to trigger a display of promotional content.

The virtual universe system 110 also includes an analytics module 145 that analyzes user information 161 and content information 163. The analytics module 145 may obtain the user information 161 and content information 163 from the virtual universe 127 and from user profiles 149. The user information 161 may include information describing users, such as identities, demographics, online behavior, advertising tracking information, and purchase information. The content information 163 may include user impressions, interactions, behavioral profiling, and content conversion information. Using the information, the analytics module 145 generates reports 165 that analyze the performance of content 157, including impressions, perceptibility, and conversions. The reports 165 may also include emulations representing how the content, such as advertisements, is perceived in the virtual universe 127 by users.

The content server 113 may be one or more computing devices communicatively linked with the virtual universe system 110, the content analytics system 115, and content providers 125. The content server 113 may maintain user profiles 149 and a content catalog 151. The user profiles 149 store user information 161 obtained and analyzed by the content analytics system 115 as well as obtained from other sources such as consumer information warehouses. For example, the user profiles 149 may record users' content views, browsing history, cookies, and purchases in the virtual universe 127 and the real world. The content catalog 151 is a database of content 153 obtained from the content providers 125. The content server 113 may serve a particular item of content 157 to the virtual universe system 110 for display on a target object 135 in response to a content request 155 from the virtual universe system 110. The content server 113 may select and serve the content 157 to the virtual universe system 110 using an auction process and/or contextual targeting.

### 3. Virtual Universe System Architecture

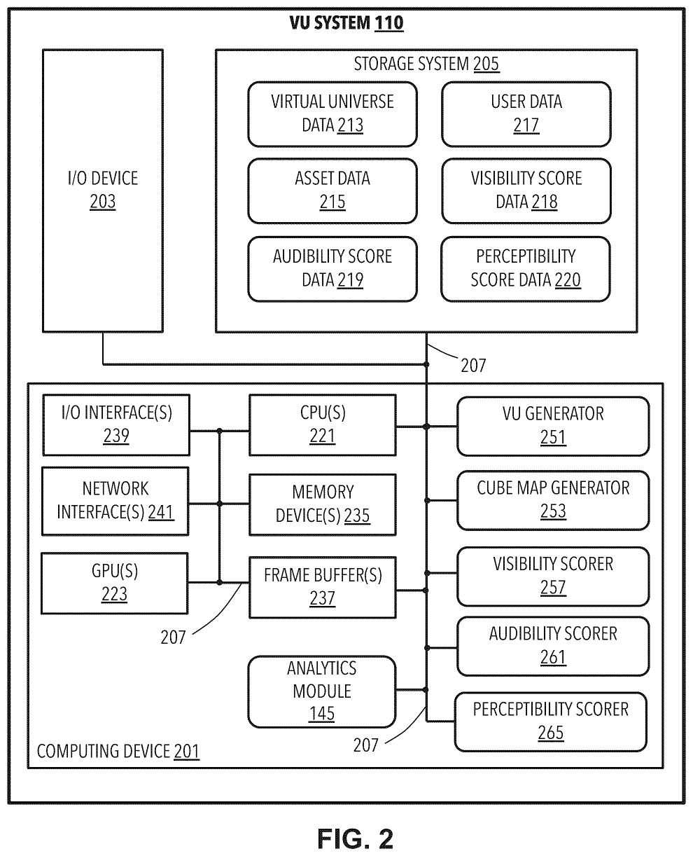

FIG. 2 is a block diagram that illustrates a virtual universe system 110 that implements one or more embodiments. The system 110 may be the same as that previously described above. The system 110 includes hardware and software that perform processes and functions described herein. In one or more embodiments, the system 110 may include more or fewer components than the components illustrated in FIG. 2. The components illustrated in FIG. 2 may be local to or remote from each other. The components illustrated in FIG. 2 may be implemented in software and/or hardware. Each component may be distributed over multiple applications and/or machines. Multiple components may be combined into one application and/or machine. Operations described with respect to one component may instead be performed by another component.

The system 110 includes a computing device 201, an input/output (I/O) device 203, and a storage system 205. Additionally, the system 110 includes a communication channel 207, such as a data bus, that communicates data between the computing device 201, I/O device 203, and the storage system 205. The I/O device 203 is any device that enables a user to interact with the system 110 and/or any device that enables the computing device 201 to communicate with one or more other computing devices and/or information networks using any type of communications link. For example, the I/O device 203 may include one or more of a touchscreen display, pointer device, keyboard, etc.

The storage system 205 comprises a computer-readable, non-transitory hardware storage device that stores information and program instructions. The storage system 205 may be, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM). In accordance with aspects of the present disclosure, the storage system 205 may store virtual universe data 213, asset data 215, user data 217, visibility score data 218, audibility score data 219, and perceptibility score data 220.

The virtual universe data 213 comprises information used to generate a virtual universe. The virtual universe data 213 may include one or more database systems, spatial databases, scene graphs, assets, scripts, and simulation data. The databases may be a relational database. The spatial databases may store spatial relationships and positioning information related to geometric and geographic data that represent the layout of the virtual universe. The scene graph is a data structure representing the spatial relationships between objects in a scene, wherein nodes in the graph represent objects. The scripts and simulation data control movement, interactions, behaviors, and physics of the virtual universe.

The asset data 215 includes data used to populate and display the virtual universe, such as object models, textures, audio files, and the like. The object models may include data modeling objects in the virtual universe, such as terrain, structures, vehicles, avatars, entities, animals, and plants. Simulations may include data and algorithms for determining dynamic aspects of the virtual universe, such as physics-based interactions and object behaviors.

The user data 217 is a database or other data repository that stores information about users, such as avatars, interactions, progress, achievements, purchases, and inventories. For example, the user data 217 may include avatar models, profiles, demographics, account information, preferences, purchase history, Internet browsing history, virtual universe interaction history, and user-generated content.

The visibility score data 218 is a dataset including visibility scores calculated for target objects in the virtual universe. The visibility score data 218 includes information that quantifies the visual discernability of content presented by target objects. One or more embodiments calculate the visibility score data 218 by determining, from a particular location, the difference between one or more images of a target object rendered with visibility factors using a cube map and an image of target objects rendered without the visibility factors.

The audibility score data 219 is a dataset including audibility scores calculated for target objects in the virtual universe. The audibility score data 219 includes information that quantifies the audible discernability of content presented by target objects. One or more embodiments calculate the audibility score data 219 by determining, from a particular location, the difference between sounds simulated at the location, including environmental sounds, sound effects, and soundtrack music, and a sound simulated at the location solely generated by the content.

The perceptibility score data 220 is a dataset including perceptibility scores calculated for target objects in the virtual universe. The perceptibility score data 220 includes information that quantifies the total visibility and/or audibility of content presented by target objects. The perceptibility score data 220 may be calculated by combining (e.g., using a weighted average or the like) the total visibility score for a target object and the audibility score for the target object. Some embodiments may weigh the visibility score and audibility score.

The computing device 201 includes one or more hardware central processors units (CPUs) 221, one or more graphic processor units (GPUs) 223, one or more memory devices 235, one or more frame buffers 237, one or more I/O interfaces 239, and one or more network interfaces 241. The CPUs 221 may be hardware computer processors, such as a general-purpose microprocessor or an application-specific integrated circuit. The GPUs 223 may be special-purpose processors that compute 2D representations of the 3D virtual universe to be displayed on a computer screen. For example, the GPUs 223 may include a processor and memory optimized for parallel processing and rendering graphics.

The memory device 235 is one or more of random-access memory (RAM), read-only memory (ROM), or other dynamic storage device coupled to bus 202 that stores information and instructions to be executed by CPU 221. The memory devices 235 also may store temporary variables or other intermediate information during execution of instructions by CPU 221 and GPU 223. Such instructions, when stored in non-transitory computer-readable storage media accessible to CPU 221, render virtual universe system 110 into a special-purpose machine that is customized to perform the operations specified in the instructions.

The frame buffer 237 is one or more memory devices or a subset of the memory devices 235 used to store graphical information for representing the virtual universe in 2D images before being sent to a display device. The frame buffer 237 holds values for each pixel of scene, including information about color, intensity, and other graphical attributes. Some embodiments maintain two frame buffers 237 storing different images showing different representations of the same scene from a same viewpoint.

The I/O interface 239 is one or more devices providing a two-way data communication between the computing device 201 and external devices. The I/O interface 239 may function as the intermediary between the CPU 221 and one or more input devices to control information and data flow therebetween. The I/O interface 239 may also function as the intermediary between the CPU 221 and one or more output devices to control information and data flow therebetween. The I/O interface 239 may be configured to understand the communication and operational details (such as hardware addresses) for the attached devices.

Network interface 241 provides data communication through one or more networks to other data devices. For example, the network interface 241 may provide a connection through local network to a host computer or to a wide area network. The signals through the various networks and the signals on network interface 241 that carry the digital data to and from virtual universe system 110 are example forms of transmission media.

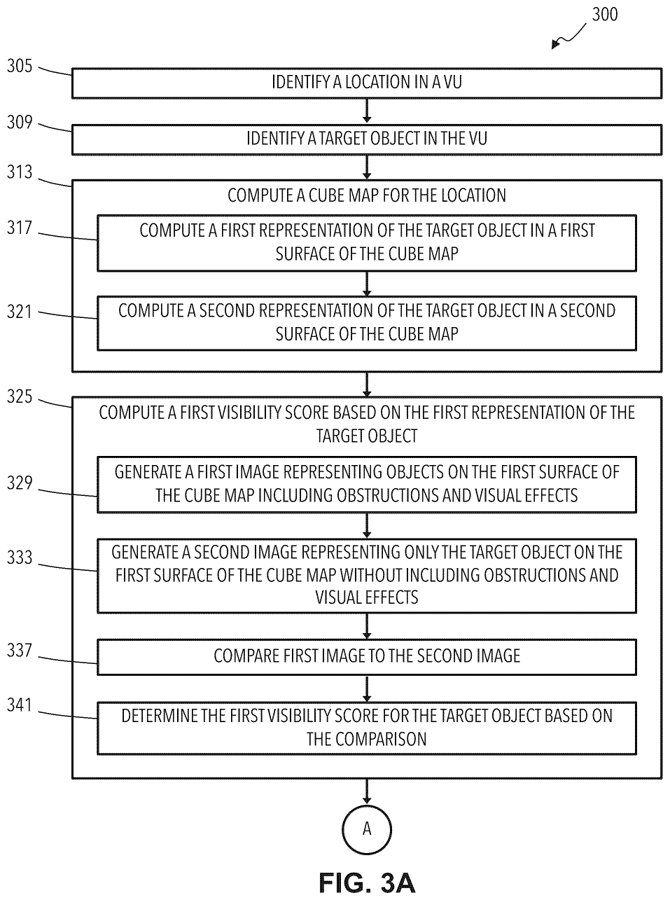

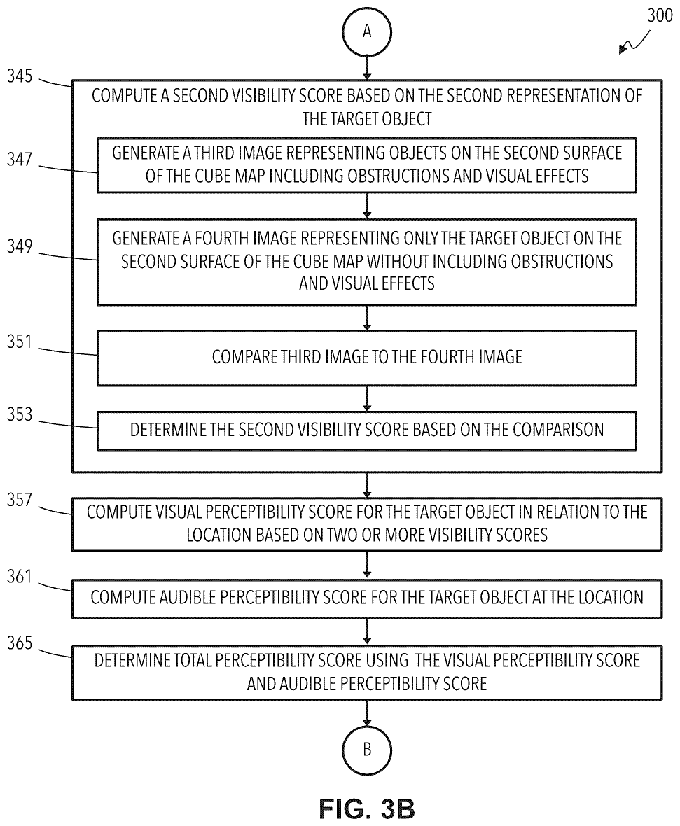

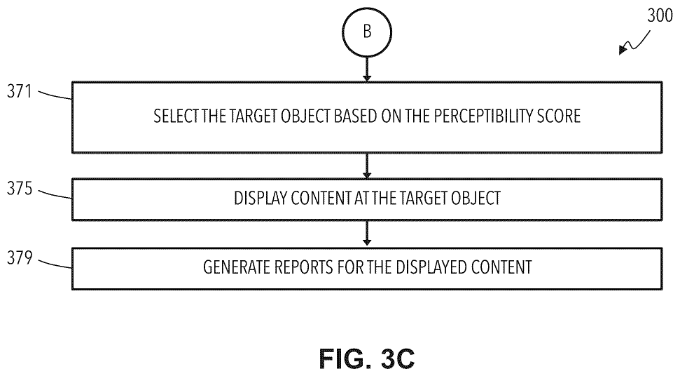

The CPU 221 executes computer program instructions, such as an operating system and application programs, that are stored in the memory devices 235 and/or the storage system 205. Moreover, the CPU 221 executes computer program instructions of an analytics module 145, a virtual universe generator 251, a cube map generator 253, a visibility scorer 257, an audibility scorer 261, and a perceptibility scorer 265. The analytics module 145, the virtual universe generator 251, the cube map generator 253, the visibility scorer 257, the audibility scorer 261, and the perceptibility scorer 265 refer to hardware and/or software configured to perform operations that determine and analyze the perceptibility of content displayed on objects in a virtual universe. The analytics module 145 may be the same as the one previously described above. Examples of operations that determine and analyze the perceptibility of content are described below with reference to FIGS. 3A, 3B, and 3C.

The virtual universe generator 251 generates a 3D virtual universe and outputs images and sounds representing the virtual universe in real time or in near real time. Operations performed by the virtual universe generator 251 include constructing a scene graph representing spatial relationships between objects in the virtual universe. The scene graph may organize objects into a tree structure with each node representing an entity or a group of entities. Constructing the scene graph also may also include performing geometric transformations, such as translation, rotation, and scaling on object models to place objects in the scene. The operations also include determining objects included in a current field-of-view and culling objects outside the field-of-view.

Additionally, the virtual universe generator 251 flattens a 3D scene of the virtual universe from a viewpoint into a 2D frame and renders a displayable image representing the scene. The virtual universe generator 251 processes each vertex in the 3D models included in the scene graph to determine transformations, lighting calculations, and other operations. The virtual universe generator 251 assembles vertices into primitives (e.g., triangles) and determines pixels covered by each primitive. For each pixel, the GPU 223 calculates the final color based on lighting, textures, and other material properties. The virtual universe generator 251 fetches texels (i.e., texture pixels) and applies them to the corresponding fragments. Further, the virtual universe generator 251 performs depth testing to determine obstructed views and objects.

The cube map generator 253 generates cube maps of the virtual universe. The cube map generator 253 generates a cube map by capturing six images from a specific location in the virtual universe, wherein each image corresponds to one face of a cube. Each of the images captured covers a different range perpendicular to one another corresponding to one face of a cube (front, back, left, right, top, and bottom).

The visibility scorer 257 renders images of the virtual universe for determining visibility scores using cube maps determined for a target object. A cube map generated by the visibility scorer 257 includes a representation of a scene as viewed from a particular location. Some embodiments compute a respective visibility score for a target object in relation to every face of the cube map. Some other embodiments compute a visibility score in relation to a subset of the faces of the cube map representing portions of the target object. For example, using the cube map, the visibility scorer 257 may generate a first image of the entire scene captured on a face of the cube map, including the target object. Additionally, the visibility scorer 257 may generate a second image of the scene captured on the same face of the cube map but solely including the target object. For the individual faces, the visibility scorer 257 determines a visibility score for the target object by comparing the first image and the second image. The comparison may include comparing the first image and the second image to identify obstructions and color-shifting due to visual effects that block any part of the target object. If the target object is not represented in a surface (e.g., entirely obstructed), the visibility score for the surface will be indicative of the non-representation of the target object within the surface.

The audibility scorer 261 renders audio of the virtual universe to determine audibility scores for content displayed by a target object. The audibility scorer 261 may simulate sounds at the viewpoint of the target location, including environmental sounds, sound effects, and soundtrack music. The audibility scorer 261 may also simulate sounds at the viewpoint of the location generated solely by the content. Based on a comparison of the simulations, the audibility scorer 261 determines an audibility score for the content's audio at the location.

The perceptibility scorer 265 determines a perceptibility score of content based on the outputs of the visibility scorer 257 and the audibility scorer 261. Based on the perceptibility score, the analytics module 145 may analyze the effectiveness and value of content presented in the virtual universe from various locations.

### 4. Measuring Perceptibility of Content

FIGS. 3A, 3B, and 3C illustrate an example set of operations of process 300 for determining a perceptibility of a content displayed in a virtual universe in accordance with one or more embodiments. One or more operations illustrated in FIGS. 3A, 3B, and 3C may be modified, rearranged, or omitted. Accordingly, the particular sequence of operations illustrated in FIGS. 3A, 3B, and 3C should not be construed as limiting the scope of one or more embodiments.

At block 305, the system identifies a location in a virtual universe for determining a perceptibility score of the target object. The location may be within visual rendering distance of a target object The visual rendering distance is the maximum distance that the virtual universe renders objects, textures, and other graphical elements. Some embodiments pre-establish the location for determining the perceptibility score. The location may be established by a manager or operator of the virtual universe at a position in view of a promotional display. For example, an operator may specify the location inside an entry of a virtual store in the virtual universe. The location may have a line-of-sight to one or more advertisement displays in the store. Some other embodiments identify the location based on the position of an avatar in the virtual universe. Locating the position of the avatar may include tracking the avatar in the virtual environment or sub-environment. One or more embodiments track the user avatar based on a username or other identifier of a target user. The tracking may begin when the target user instantiates their avatar in the virtual universe or when the user controls the avatar to cross a predetermined barrier. For example, a system may begin tracking a position of the avatar after the avatar crosses a doorway of a virtual shop. Tracking the avatar may also include obtaining information of the target user, such as contact information, internet protocol address of the user device, a unique identifier of the user device, or the like. The system may store user data identifying information of the avatar and of the target user for tracking user activity as well as impressions and conversions associated with the content.

At block 309, the system identifies a target object in the virtual universe. Some embodiments identify target objects that have been preselected by a manager or operator of the virtual universe. Some embodiments identify target objects based on location, demographics, and/or contextual relevance. For example, the system may identify a target object based on target user information coinciding with regional information. Regions of the virtual universe may be sub-environments that have different contexts and may be frequented by users who have similar demographics. The system may identify a target object in a region including context, products, or services that align with profile information of the target user.

At block 313, the system computes a cube map at the location. Computing the cube map includes capturing a scene from a viewpoint, rendering one image of the scene for each of the six faces of the cube, and saving the results as one or more textures. The viewpoint may be at the location of a target avatar in the direction of the avatar's line-of-sight. The system may capture the scene by placing six virtual cameras at the viewpoint with each camera facing different directions corresponding to one face of a cube (e.g., front, back, left, right, top, and bottom). The six faces of a cube map may represent the following directions with respect to the viewpoint: Positive X (+X): Right direction; Negative X (−X): Left direction; Positive Y (+Y): Up direction; Negative Y (−Y): Down direction; Positive Z (+Z): Forward direction; Negative Z (−Z): Backward direction. The system renders images for each direction, including content visible from the corresponding camera, and arranges the six images into 2D images. The system may then map the images onto a cube map texture that has six regions corresponding to the respective faces of the cube. Depending on the viewpoint, one or more faces of the cube map may include portions of the target object. For example, the front face of the cube map may include a first portion of the target object, and the right face may include a second portion of the target object. Accordingly, computing the cube map may include, at block 317, computing a first representation of the scene including the target object in a first surface of the cube map. Additionally, computing the cube map may include, at block 321, computing a second representation of the target object in a second surface of the cube map.

Some embodiments compute a visibility score for each face of the cube map. Some other embodiments compute visibility scores in relation to the subset of the Some embodiments compute a visibility score for each face of the cube map. Some other embodiments compute visibility scores in relation to the subset of the surfaces of the cube map including portions of the target object. of the cube map including portions of the target object. For example, at block 325, the system computes a first visibility score based on the first representation of the target object. Using the cube map, the system determines the first visibility score by comparing different images of the first representation, including the target object. Computing the first visibility score includes, at block 329, generating a first image representing objects in the scene of the virtual universe included on the first surface of the cube map. The first image may correspond to the front-face of the cube map. The system may determine the obstructions in the image by calculating spatial relationships of objects in a scene graph and performing depth testing on the objects. Additionally, the system may determine visual effects for each pixel in the scene by computing an effect vector based on the viewpoint and a surface normal representing the direction from a visual effect to the viewpoint. A sampled color from the cube map at a particular point represents the visual effect on the object's surface at a respective pixel. The sampled color from the cube map may be blended with the properties of the object's texture, such as diffuse and specular colors. The final color is then used in the shading calculation for the pixel of the target object in the first representation.

Computing the first visibility score also includes, at block 333, generating a second image representing the target object in the scene included on the first surface of the cube map without obstructions and visual effects. The system may selectively render the scene with the target object such that the second image excludes the other objects, obstructions, and visual effects. As a result, the second image may comprise pixels having colors unaffected by obstructions, visual effects, and shading. Some embodiments selectively render the solely target object using a stencil buffer to mask out areas of the scene other than the target object such that specific pixels corresponding to the target object are rendered. Some other embodiments selectively render the target object, without other objects, by assigning the target object to a particular depth or render layer and rendering that depth or layer.

Computing the first visibility score further includes, at block 337, comparing the first image to the second image to quantify an amount of the content visible in the first image relative to the second image. Comparing the first image to the second image may include making pixel-by-pixel comparisons between the first image and the second image. For the individual pixels, the system determines (a) pixels in the first image belonging to the same object as the corresponding pixel of the target object in the second image and (b) pixels in the first image color-shifted from pixels in the second image.

Some embodiments determine if a pixel in the first image and second image belongs to the same object based on metadata stored in textures of the target object. For example, the textures of the target object may be modified to include metadata identifying the target object or content regions of the target object. The metadata may be incorporated in the data structure of the textures such as included in red-green-blue-alpha (RGBA) data. By making a pixel-by-pixel comparison of the first image to the second image, the system may determine if each pixel of the target object in the second image is included in the first image. Then, the system may determine a total portion of the target object or content obstructed in the second image. For example, the obstruction may be a value ranging from 0 to 5, where 0 represents 100% obstruction, and 5 represents 0% obstruction.

Some other embodiments determine if content is visible by comparing the colors of corresponding pixels in the first and second images based on color and/or intensity. The system may compare the first image and second images by calculating a perceptual color difference. The perceptual color difference may be determined based on color, brightness, and saturation using standard metrics, such as CIE76, CIE94, and CIEDE2000. For example, the system may measure the Euclidean distance between the colors of corresponding pixels of the first and second images, including lightness, a color position on the green to red axis, and a color's position on a blue to yellow axis. Then, based on the calculated distance, the system may assign a value representing the perceptual color distance. For example, the system may assign the following values based on a calculated perceptual color difference: strong match, >4 to 5; weak match, >3 to 4; indeterminate, >1 to 3; and distinct, ≤1.

Computing the first visibility score also includes, at block 341, determining the first visibility score based on the comparing of block 337. The system may calculate the visibility score by combining the obstruction value and the perceptual color difference. The different values may be scaled, normalized, and weighted prior to being combined. Some embodiments determine the visibility score by proportionally combining the individual pixel scores. As a simplified example, an image having 1000 pixels may include 667 pixels having a perceptual color difference value of 4, 167 pixels having a perceptual color difference value of 3, and 166 pixels having a perceptual color difference value of 0 or are obstructed. The visibility score for the image may be 0.667*4+0.167*3+0.166*0=3.2.

Continuing to block 345 in FIG. 3B, as indicated by off-page connector “A,” the system computes a second visibility score for the target object based on the second representation. The system may compute the second visibility score using the same operations as those used to compute the first visibility score as described above for block 325. That is, computing the second visibility score includes, at block 347, generating a third image that represents objects in the scene of the virtual universe included on the second surface of the cube map, including obstructions and visual effects. Computing the second visibility score may also include, at block 349, generating a fourth image that represents the target object in the scene included on the second surface of the cube map without other objects, obstructions, and visual effects. Computing the second visibility score may further include, at block 351, comparing the third image to the fourth image. Additionally, computing the second visibility score may include, at block 353, generating the computability score based on the comparison.

At block 357, the process 300 computes a visual perceptibility score for the target object in relation to the location based on two or more visibility scores computed for the target object and corresponding to respective surfaces of the cube map. As noted above, some embodiments compute a visibility score for each face of the cube map, whereas some embodiments compute visibility scores in relation to the subset of the faces. For example, the system may combine the first and second visibility scores by adding or averaging the first and second visibility scores. Some embodiments weigh the individual visibility scores by the proportional area or quantity of pixels of the target object included in each of the first and second images.

At block 361, the process 300 computes an audibility perceptibility. The audible perceptibility score represents a difference between audible discernability of the content from the location when (a) measured with ambient sounds in the virtual universe and (b) rendered without the ambient sounds. Ambient sounds may include background music, environmental sounds, and sound effects generated by objects. For example, an advertisement displayed on a billboard in a virtual coffee shop may include audible content. The system may determine an audibility score for the advertisement measured at a location by comparing (a) volume of the content at the location when mixed with ambient sounds occurring in the shop and (b) volume of the content at the location without the ambient sounds. The system simulates the sounds coming from different directions at the location by calculating the position of sound sources in relation to the location and adjusting the volume, pitch, and other parameters.

At block 365, the process 300 computes a total perceptibility score. The total perceptibility score may be calculated by combining the total visibility score and the audibility score. Some embodiments may weigh the visibility score and audibility score. The weights may be predetermined values. Additionally, the weights may give greater importance to the visibility score. For example, (Weight 1*visibility score)+(Weight 2*audibility core), wherein the weight of the visibility score is greater than the weight of the audibility score.

Continuing to block 371 in FIG. 3C, as indicated by off-page connector “B,” the process 300 selects the target object for presenting content based on the perceptibility score. A target object having a higher perceptibility score than other target objects will result in a greater number and/or value impressions and conversions. As such, the first target object is expected to have a value greater than the other targets object that have lower perceptibly scores. Depending on the application, placement of content at the target object may be associated with payment of compensation to the content provider or payment of a fee by the content provider. Some embodiments select the target object for placement of the content using a competitive process. For example, the system may use an auction method to select the target object that displays content by advertisers. Advertisers interested in displaying content for a particular audience or keyword may submit bids for their content to be displayed. The value of a particular target object may correspond to the perceptibility score of the target object. The value may also vary based on other factors, such as time of day, location, device type, and context. For example, the target object may be in a high-traffic and/or demographically desirable location in the virtual universe or have a high perceptibility score relative to other locations.

At block 375, the process 300 displays the selected content at the target object. The system may obtain the selected content from a content server. Using the selected content, the system may update the virtual universe scene to render the content on the target object. For example, the system may retrieve an advertisement of an advertiser submitting a winning bid for placement on the target object and map the advertisement to the display region of the target object.

At block 379, the process 300 generates reports for the displayed content. The reports may include perceptibility information, user demographics, impressions, user engagement, conversions, and emulations. Perceptibility information may include time of day, day of the week, or specific events within the virtual universe that impact user engagement. Engagement metrics include, views, and interactions. Impressions and conversions may measure effectiveness of the content displayed at the location. An impression refers to the presentation of the content on a user's display. An impression occurs each time a content item appears on a target object, regardless of whether or not the user interacts with the content. Impressions may be linked to conversions. A conversion refers to a user taking desired action because of an impression or interaction with content. The specific action that defines a conversion can vary based on the goals of the advertising campaign and the objectives of the advertiser.

Content providers may be compensated based on impressions and conversions. Some embodiments compensate impressions using a price per impression model. For example, a content provider can be compensated an amount for every thousand impressions. Some embodiments compensate conversions based on a user undertaking a specific action after viewing or interacting with content. The action could be purchasing an item, signing-up for a service, participating in an event, downloading information, etc. For example, a content provider may be compensated a fixed amount for each conversion.

### 5. Example of Determining Images for Computing Visual Perceptibility

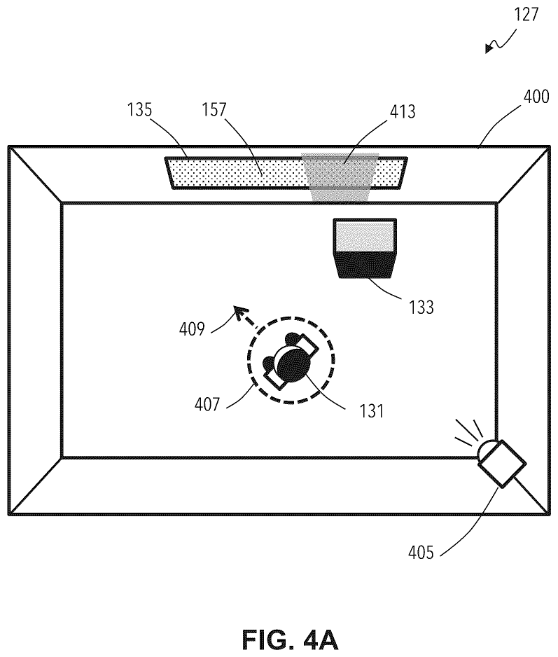

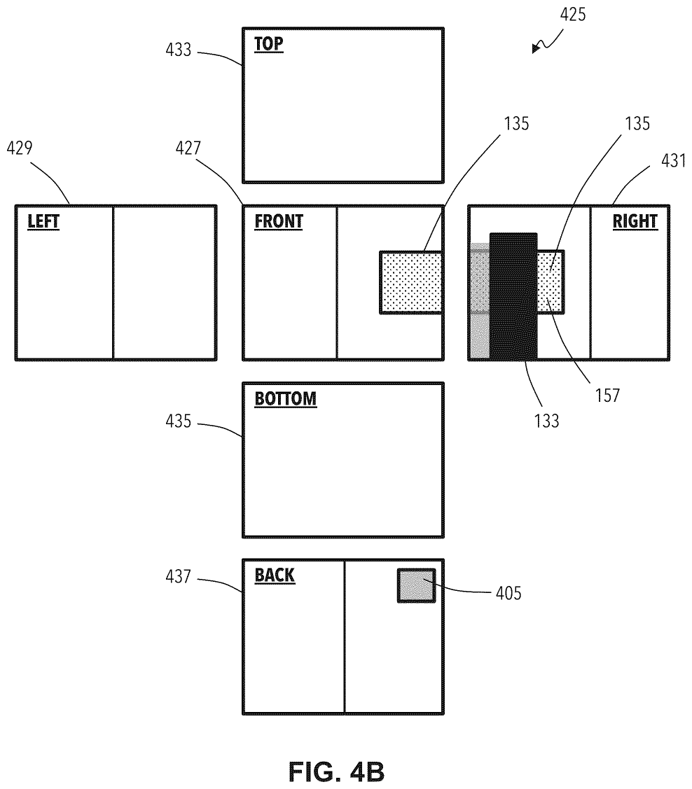

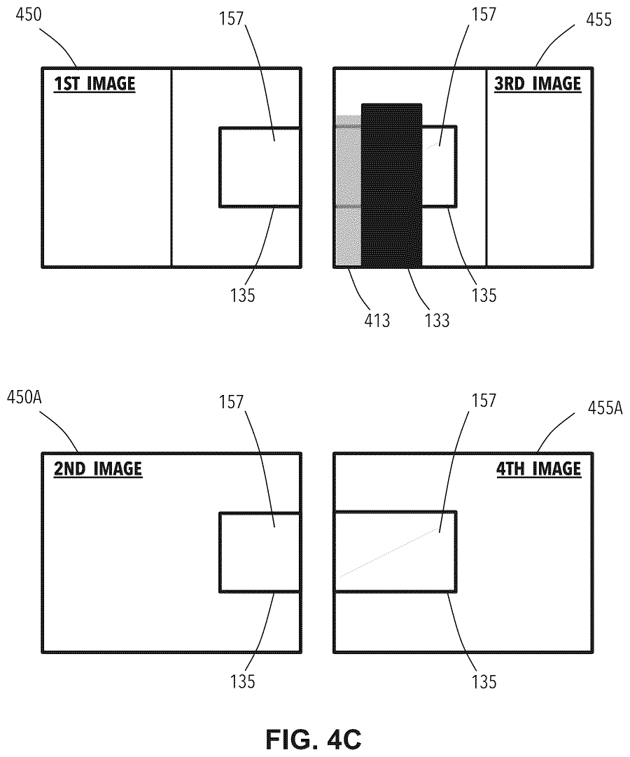

FIGS. 4A, 4B, and 4C illustrate an example of determining images for computing a perceptibility score in a virtual universe. The example embodiment below should be understood as one specific example that may not be applicable to certain embodiments. Accordingly, components and/or operations described below should not be construed as limiting the scope of any of the claims.

FIG. 4A represents an example sub-environment 400 of the virtual universe 127 produced by a virtual universe system. The sub-environment 400 may be, for example, a room including a target avatar 131, an object 133, a target object 135, and content 157. The virtual universe 127, the target avatar 131, the object 133, the target object 135, and content 157 may be the same as those previously discussed above. For the sake of example, the target object 135 may be a billboard located on a wall of the room, and the content 157 may be an advertisement displayed on the billboard. The object 133 may be a box positioned between the target avatar 131 and the target object 135. Additionally, the sub-environment 400 includes a spotlight 405 on the wall of the room opposite from the target object 135. The spotlight 405 projects bright light toward the target object 135 and causes the object 133 to cast a shadow 413 on a portion of the content 157.

The system determines a perceptibility score for the content 157 from the viewpoint 409 of the target avatar 131. The determination may be triggered manually by an operator, periodically by the system, or dynamically by the position of the target avatar 131. As detailed above, the system may initially identify the target object 135 and the location 407 to determine the perceptibility score of the content 157. Next, the system generates a cube map for the location 407 of the target avatar 131. As shown in FIG. 4B, a cube map 425, in accordance with the present example, comprises six faces in different directions, including a front face 427, a left face 429, a right face 431, a top face 433, a bottom face 435, and a back face 437. The individual faces 427 to 437 span respective portions of the scene in the sub-environment 400. For example, the front face 427 may be directed forward in the direction of the viewpoint 409 and span a 90-degree range in the horizontal and vertical directions.

As illustrated in FIG. 4B, the cube map 425 includes a portion of the target object 135 in the front face 427 and another portion of the target object 135 in the right face 431. Also captured in the right face is the object 133 and the shadow 413. Further, the back face 437 includes the spotlight 405. Using the cube map 425, the system determines images of the virtual universe 127 corresponding to, at least, the faces of the cube map 425, including the target object 135. Some other examples may determine images for each face of the cube map. As illustrated in FIG. 4C, the system generates a first image 450 representing the portion of the target object 135 on the front face 427, including other objects, obstructions, and visual effects captured by the cube map 425. The system may render and store the image 455 in a first frame buffer. Additionally, the system generates a second image 450A representing the portion of the target object 135 on the front face 427 without including the other objects, obstructions, and the visual effects captured by the cube map 425. The system may render and store the image 450A in a second frame buffer. In the present example, the first image 450 and the second image 450A are substantially equivalent because the cube map 425 lacked any obstructions (such as object 133) or visual effects (such as the shadow 413) in the front face 427.

Next, the system determines visibility scores using the images stored in the frame buffers. As noted above, some embodiments compute a visibility score for each face of the cube map. For the sake of simplicity, the present example computes visibility scores in relation to the subset of the faces. By comparing the first image 450 to the second image 450, the system determines and stores a first visibility score for the target object 135. The system may perform a pixel-by-pixel comparison of the first image 450 in the first frame buffer to the second image 450A in the second frame buffer. For example, based on the comparison, the system may calculate perceptual color differences resulting from obstructions and visual effects. Then the system may determine a proportion of the pixels that exactly match and that substantially match. For example, the system may determine proportion of the 100% of the pixels have a perceptual color different score equal to 5, indicating that the content 157 in images 450 and 450A is effectively identical.

Still referring to FIG. 4C, the system also generates an image 455 representing the target object on the right face 431 of the cube map 425, including obstructions and the visual effects captured by the cube map 425. For example, the system may render and store the image 455 in a first frame buffer. The image 455 includes representations of a portion of the content 157 rendered on the target object 135, the object 133, and the shaded portion of the content 157. Additionally, the system generates image 455A representing the target object on the right face 431 without including any obstructions and visual effects. For example, the system may render and store the image 455A in a second frame buffer that includes a representation of the target object 135 but excludes the obstruction and shading of the object 133.

Further, the system compares the image 455 in the first frame buffer to the image 455A in the second frame buffer to determines and stores second visibility score for the target object 135. As previously described, the system may perform a pixel-by-pixel comparison of the image 455 and the image 455A. For example, the system may calculate a perceptual color difference for respective pixels of the image 455 to the second image 455A. In the present example, the system may determine the portion of the content 157 rendered on the target object 157 has a perceptual color difference score greater than or equal to 2, the pixels of the content 157 have a score greater than or equal to 5, and the pixels of the shadow 413 have a score of 3. For the sake of example, assume the representation of the object comprises 50% of the content 157 and has a perceptual color difference of >5, the representant of the shaded shadow 413 comprises 25% of the content and has a perceptual color difference of >3, and the representant of the unaffected portion of the content 157 comprises 25% of the content and has a perceptual color difference of >1.

The system combines and stores the visibility scores determined for the front face 427 and the right face 431 of the cube map 425. Some embodiments average the visibility scores. Some embodiments weigh the individual visibility scores by the proportional area or quantity of pixels of the target object, including each of the faces 427 and 431. They system may combine visual perceptibility score with an audible perceptibility score to determine a total perceptibility score for the content 157.

### 6. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

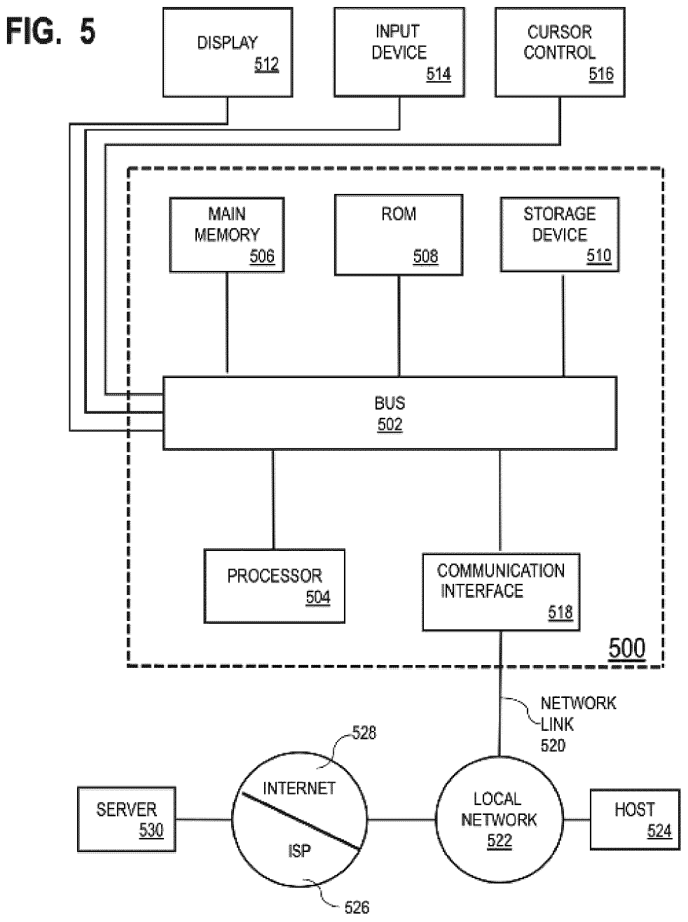

For example, FIG. 5 is a block diagram that illustrates a computer system 500 upon which an embodiment of the disclosure may be implemented. Computer system 500 includes a bus 502 or other communication mechanism for communicating information, and a hardware processor 504 coupled with bus 502 for processing information. Hardware processor 504 may be, for example, a general-purpose microprocessor.

Computer system 500 also includes a main memory 506, such as a random-access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or a Solid-State Drive (SSD) is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 502. Transmission media may also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer may load the instructions into its dynamic memory and send the instructions over a telephone line using a modem. A modem local to computer system 500 may receive the data on the telephone line and use an infra-red transmitter to convert the data to an infra-red signal. An infra-red detector may receive the data carried in the infra-red signal and appropriate circuitry may place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 may send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

### 8. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer readable media comprising instructions that, when executed by one or more hardware processors, cause the one or more hardware processors to perform operations comprising:
computing a cube map for a location within a virtual reality environment, the virtual reality environment including a target object;
computing a first representation of the target object in a first surface of the cube map;
computing a second representation of the target object in a second surface of the cube map;
generating a plurality of visibility scores, the plurality of visibility scores comprising:
a first visibility score computed based on the first representation of the target object in the first surface of the cube map;
a second visibility score computed based on the second representation of the target object in the second surface of the cube map; and
computing a perceptibility score for the target object, within the virtual reality environment, in relation to the location based on the plurality of visibility scores.

2. The one or more non-transitory computer readable media of claim 1, wherein computing the first representation of the target object in the first surface of the cube map is based on information for the target object in a frame buffer corresponding to the first surface.

3. The one or more non-transitory computer readable media of claim 1, wherein the operations further comprise:
generating a first frame in a first frame buffer representing a set of objects on a first surface of the cube map;
generating a second frame in a second frame buffer representing the target object on the first surface without other objects in the set of objects; and
generating the plurality of visibility scores comprises comparing pixels corresponding to the first frame buffer and pixels corresponding to the second frame buffer.

4. The one or more non-transitory computer readable media of claim 1, wherein:
the cube map comprises six images having different viewing angles of the virtual reality environment, the six images surrounding a viewpoint of a virtual entity at the location.

5. The one or more non-transitory computer readable media of claim 1, wherein:
the operations further comprise computing an audibility score comprising a value representing a level of sound emitted from the target object at the location in relation to a combined level of other sounds of the virtual reality environment at the location; and
computing the perceptibility score for the target object using the audibility score.

6. The one or more non-transitory computer readable media of claim 1, wherein the operations further comprise:
selecting the target object for display of content by comparing the perceptibility score of the location to perceptibility scores of one or more other target objects in the virtual reality environment.

7. The one or more non-transitory computer readable media of claim 1, wherein:
the visibility scores are based on one or more of: obstructions and perceptible color difference.

8. The one or more non-transitory computer readable media of claim 1, wherein:
the target object comprises textures having red-green-blue-alpha (RGBA) information including an identifier of an advertisement; and
determining individual visibility scores of the target object comprises determining whether pixels of the cube map include the identifier of the advertisement.

9. A method comprising:
computing a cube map for a location within a virtual reality environment, the virtual reality environment including a target object;
computing a first representation of the target object in a first surface of the cube map;
computing a second representation of the target object in a second surface of the cube map;
generating a plurality of visibility scores, the plurality of visibility scores comprising:
a first visibility score computed based on the first representation of the target object in the first surface of the cube map;
a second visibility score computed based on the second representation of the target object in the second surface of the cube map; and
computing a perceptibility score for the target object, within the virtual reality environment, in relation to the location based on the plurality of visibility scores.

10. The method of claim 9, wherein computing the first representation of the target object in the first surface of the cube map is based on information for the target object in a frame buffer corresponding to the first surface.

11. The method of claim 9, further comprising:
generating a first frame in a first frame buffer representing a set of objects on a first surface of the cube map;
generating a second frame in a second frame buffer representing the target object on the first surface without other objects in the set of objects; and
generating the plurality of visibility scores comprises comparing pixels corresponding to the first frame buffer and pixels corresponding to the second frame buffer.

12. The method of claim 9, wherein the cube map comprises six images having different viewing angles of the virtual reality environment, the six images surrounding a viewpoint of a virtual entity at the location.

13. The method of claim 9, wherein:
the method further comprises computing an audibility score comprising a value representing a level of sound emitted from the target object at the location in relation to a combined level of other sounds of the virtual reality environment at the location; and
computing the perceptibility score for the target object using the audibility score.

14. The method of claim 9, further comprising:
selecting the target object for display of content by comparing the perceptibility score of the location to perceptibility scores of one or more other target objects in the virtual reality environment.

15. The method of claim 9, wherein the visibility scores are based on one or more of:
obstructions and perceptible color difference.

16. The method of claim 9, wherein:
the target object comprises textures having red-green-blue-alpha (RGBA) information including an identifier of an advertisement; and
determining individual visibility scores of the target object comprises determining whether pixels of the cube map include the identifier of the advertisement.

17. A system comprising:
at least one device including a hardware processor;
the system being configured to perform operations comprising:
computing a cube map for a location within a virtual reality environment, the virtual reality environment including a target object;
computing a first representation of the target object in a first surface of the cube map;
computing a second representation of the target object in a second surface of the cube map;
generating a plurality of visibility scores, the plurality of visibility scores comprising:
a first visibility score computed based on the first representation of the target object in the first surface of the cube map;
a second visibility score computed based on the second representation of the target object in the second surface of the cube map; and
computing a perceptibility score for the target object, within the virtual reality environment, in relation to the location based on the plurality of visibility scores.

18. The system of 17, wherein the operations further comprise:
generating a first frame in a first frame buffer representing a set of objects on a first surface of the cube map;
generating a second frame in a second frame buffer representing the target object on the first surface without other objects in the set of objects; and
generating the plurality of visibility scores comprises comparing pixels corresponding to the first frame buffer and pixels corresponding to the second frame buffer.

19. The system of 17, wherein:
the operations further comprise computing an audibility score comprising a value representing a level of sound emitted from the target object at the location in relation to a combined level of other sounds of the virtual reality environment at the location; and
computing the perceptibility score for the target object using the audibility score.

20. The system of 17, wherein the operations further comprise:
selecting the target object for display of content by comparing the perceptibility score of the location to perceptibility scores of one or more other target objects in the virtual reality environment.
